(19) United States
(12) Patent Application Publication
(10) Pub. No.: US 2010/0175270 A1
(43) Pub. Date: Jul. 15, 2010

(54) RAZOR HANDLE GRIPS

(75) Inventors: Yiannis Marios Psimadas, Vrilissia-Athens (GR); Spiros Gratsias, Kypseli-Athens (GR); Dmitiris Efthimiadis, Krypseli-Athens (GR)

Correspondence Address: JONES DAY, 222 EAST 41ST ST, NEW YORK, NY, 10017, US

(73) Assignee: BIC Violex SA, Anixi-Attiki (GR)

(21) Appl. No.: 11/994,084

(22) PCT Filed: Jun. 28, 2005
(86) PCT No.: PCT/EP05/07901

§ 371 Date: Dec. 27, 2007

(51) Int. Cl. B26B 21/52

(52) U.S. Cl. 30/526

(57) ABSTRACT

A handle provided with an improved grip structure for a wet or safety razor that includes a rigid plastic part and preferably a compressible part. The handle includes bumps provided on a lower, front part of the handle.

### CROSS-REFERENCE TO RELATED APPLICATION

This application is a national stage application of International Application No. PCT/EP2005/007901, filed on Jun. 28, 2005, the entire contents of which is incorporated herein by reference.

### FIELD OF THE INVENTION

Embodiments of the present invention relate to a wet or safety razor. More particularly, embodiments of the present invention relate to an ergonomic handle provided with an improved grip structure for a wet or safety razor.

### BACKGROUND OF THE INVENTION

Many types of wet or safety razors (referred hereinafter as safety razors) are known in the art. Razors usually comprise a handle portion, at the front end of which a razor blade unit comprising one or more blades is disposed.

The structure of the handle portion is important for an optimal position of the grip, providing an optimal shaving angle to one or more blades with respect to the surface of skin. Gripping pads or ribs have been provided on the surface of the handles.

However, many known types of handles are limited in their gripping properties, particularly when the handle is used in a soapy and watery environment. Thus, although the gripping pads or ribs are often made for shaving, particularly precision shaving, more particularly when the handle is pinched close to the razor blade unit between the index fingers and the thumb of the user.

Although some known types of handles make it possible to obtain a good gripping, research is still going on into handles with even better qualities, particularly in regard to precision shaving particularly when the user holds the handle pinched close to the razor blade unit between the index finger and the thumb.

US 2004/0055159 discloses a V-shaped razor, comprising two elongate arms, each arm having one end joined to define a vertex, each arm having a distal end opposite the vertex; a flexible and elongated blade housing pivotally attached between the distal ends of the elongated arms; and at least one elongated blade mounted to the housing; wherein the blade housing and the attached blade flex into a concave shape and into a convex shape in order to conform to the contours of a user's body.

The handle further comprises a slender, flexible, curved cross member which bows toward the user's hand between the arms, connecting with the arms provided with bumps.

### SUMMARY OF THE INVENTION

The applicant has designed a new types of single arm handles which are provided with bumps on the lower side of the handle in the front part of the handle.

It has been noted in a surprising and unexpected fashion that the use of the new types of handles of the invention allows the razor blade unit to be precisely guided with the result that a very good shaving is obtained on difficult surfaces of the skin such as under the nose or close to the ears.

### DESCRIPTION OF THE PREFERRED EMBODIMENTS

A subject of an embodiment of the present application is therefore a handle provided with an improved grip structure for a wet or safety razor, comprising a rigid plastic part and preferably a compressible part, wherein said handle comprises bumps provided on the lower side of the handle in the front part of the handle. The bumps protrude above a surface of the handle.

By “in the front part of the handle”, is meant that the bumps are provided less than 5 cm from the cutting edge of the blade or of the blade which is most close to the bumps, preferably between 0.5 and 4.0 cm, more preferably between 0.5 and 3.0 cm, particularly between 0.25 and 2.5 cm, more particularly between 0.5 and 2.0 cm. The distances here above are calculated from the centre of the bumps.

In preferential conditions, the transversal cross section of the handle is generally V shaped for more than 30% of the length of the handle, preferably more than 50%, more preferably more than 70%, even more preferably about the entire length of the handle.

The number of bumps is for example from 4 to 20, preferably 6 to 14, more preferably 8 to 12, even more preferably 9 to 11.

Though the bumps may have any suitable shape, cubic or frustoconical for example, in other preferential conditions, the bumps are hemispheric. The above designs are suitable particularly in view of the demoulding of the handle, if prepared my moulding operations. Additionally a substantially hemispheric shape of the bumps provides the best gripping effect.

The height of the bumps may be constant. However, the height of the bumps may progressively increase from a smaller height backwards of the handle, to a greater height towards the blades, or conversely.

The height of the rubber bumps may be for example from 0.2 to 2.0 mm, preferably 0.6 to 1.6 mm more preferably 0.9 to 1.1 mm above the surface of the handle.

The spacing between two adjacent bumps may be for example from 0.2 to 5.0 mm, preferably 1.2 to 4.2 mm more preferably 1.8 to 3.7 mm.

The width (or diameter for hemispheric or like bumps) of a bump may be for example from 0.4 to 4.0 mm, preferably 1.2 to 3.2 mm, more preferably 1 to 2 mm.

The handle of an embodiment of the invention preferably has a composite structure comprising a substantially rigid backbone of an injected moulded thermoplastic, non elastomeric materials and a flexible part made of an injected moulded elastomeric material. Some places of the surface of the handle are constituted by the non elastomeric material and the others by the elastomeric material. As regards the rear half part of the top of the handle, preferably more than 50%, more preferably more than 60%, even more preferably more than 70% of the surface is made of rigid plastic material.

The bumps may be particularly made of right plastic material, preferably the same materials as used for the right backbone, or may be made of rubber material (or elastomeric material).

Still as regards the rear half part of the top of the handle, preferably the same materials as used for the rigid backbone, or may be made of rubber materials (or elastomeric material).

Under preferred conditions for implementing the invention, the present handle is obtained in a two step process.

A subject of an embodiment of the present invention is also a method for making a razor handle as disclosed above comprising moulding a backbone portion of a rigid plastic material, and moulding an elastomeric grip portion on said backbone portion, wherein bumps are provided on the surface of the lower side of the front part of the handle.

Under other preferred conditions for implementing the invention, channels are provided in the backbone portion of the handle in the front part of the handle such that rubber bumps may be created by feeding the elastomeric material from below the plastic rigid surface, through the channel holes opened on the lower surface of the handle. Rubber bumps provided on a rigid plastic.

Under further preferred conditions for implementing an embodiment of the invention, the bottom surface of the front part of the handle is constituted by elastomeric material as well as the bumps. However, rigid plastic bumps may also be provided on the elastomeric surface.

In the system of the present invention, the term “rubber” indicates preferably an elastomeric plastic materials, more preferably a mouldable elastomeric material, allowing for ample compression by the user while not requiring an excessive force. Examples of such materials are for example any elastomeric composition known in the art and of any elastomeric hardness range, especially those suitable for making a grip portion, and those that are in the Shore A hardness range. This includes elastomers and thermoplastic elastomers, as well as blends thereof. Suitable elastomers include nitrile rubbers (NBR), stryrene butadiene rubbers (SDR), ethylene-propylene terpolymers (EPDM), and (compatible) mixtures thereof Examples of suitable thermoplastic elastomers include styrene block copolymers, e.g. styrene-butylene block copolymers (SBS), styrene-ethylene-butylene block copolymers (SEBS), thermoplastic polyurethanes, polyether block amides, copolyesters, thermoplastic polyolefins (EPDM/PP, NBR/PP . . . ), and (compatible) blends thereof Moreover, said elastomeric material may contain one or more additives. Examples of additives include chemicals commonly classed as antioxidants, UV-stabilisers, adhesion modifiers, smell reducers and other such materials that are known to those skilled in the art. Additives improve the processing of said material, enhance its shelf-life and service durability, improve the adhesion to substrate “polymeric supports” that are not inherently inter-compatible and delay inherent sensory defects, such as the inherent typical smell of elastomers and elastomeric compounds.

The handles according to the embodiments of the present invention have advantageous properties because of the bumps provided on the bottom side of the handle since the later improved the controllability and the grip-ability of the razor especially when precision shaving is required in wet and humid environments when the razor is held upside-down and more preferable when the index and/or thumb fingers are in contact with the bumps defending the gripping position.

The bumps prevent the thumb from slipping particularly during precision shaving.

Also, a handle provided with such an arrangement of bumps shaped and dimensioned as described above provide the user with an improved tactile feel as well.

A safety razor having a handle, which is shaped as described above, ensures an optimal ergonomic grip by the user during precision shaving.

Preferred conditions for implementing the bumps described above also apply to the other subjects of the invention envisaged above, particularly to the method of making razor handle as disclosed above.

The scope of the invention can be understood better by referring to the description given below, the aim of which is to explain the advantages of the invention.

### DESCRIPTION OF THE DRAWINGS

FIG. 1 is a bottom plan view of the front part of a safety razor in accordance with one embodiment of a handle of the invention.

FIG. 2 is a side elevation view of the front part of a handle of a safety razor in accordance with one embodiment of a handle of the invention.

FIG. 3 is a variant of FIG. 2.

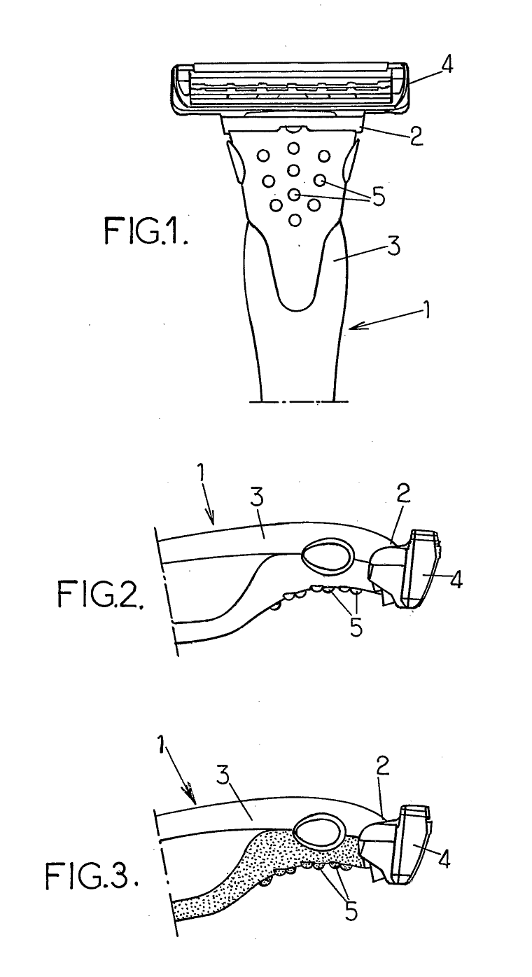

Referring to FIG. 1, a safety razor comprises a handle 1 having an elongated body portion for hand grasping the user; the front part of the handle 1 is represented on FIG. 1. The whole handle 1 preferably has a length of about 12 cm as measured along its body between the back end (not shown) and the front end 2. The handle 1 comprises a backbone 3 made of a mouldable rigid plastic material, and a partial layer of mouldable elastomeric material (not shown) allowing for compression by the user while not requiring an excessive force.

The safety razor includes a razor blade unit 4 having a rigid plastic body provided with multiple blades fixed in the plastic body.

Preferably ten rigid plastic bumps 5, integral with the backbone 3 are provided towards the front of the handle on the bottom surface thereof, and protrude above the said surface. Four bumps 5 are aligned according to a symmetry longitudinal axis of the handle and six further bumps 5 are provided according to a curve on each side of the alignment of the central bumps.

The rigid plastic bumps 5 are made of the same above rigid plastic material as the backbone 3.

As seen on FIG. 2, the safety razor includes a gently curved handle 1. Rigid plastic bumps 5, integral with the backbone 3 are provided on the bottom surface of the front part of the handle.

The general shape of the bumps 5 is hemispheric. The top and the bottom surface of the front part of the handle are gently curved.

The razor is optimally guided by the finger of the user during shaving.

As seen on FIG. 3, the bumps 56 are not integral with the backbone 3 as on FIG. 2, but are made of mouldable elastomeric material. A partial layer of mouldable elastomeric material is provided on the bottom part of the handle, and the bumps 5 are integral with the layer of mouldable elastomeric material.

According to another variant of implementation of the invention (not shown), channels are provided in bottom part of the backbone portion of the front part of the handle such that rubber bumps 5 were created by feeding the elastomeric material from below the plastic rigid surface, through channel holes opened in the bottom surface of the handle. Rubber bumps provided on a rigid plastic bottom surface of the front part of the handle were thus obtained.

1-10. (canceled)

11. A handle provided with an improved grip structure for a razor having at least one blade comprising a rigid plastic part and a compressible part wherein said handle includes bumps provided on a lower side of the handle in a front part of the handle, and wherein the bumps are provided from 0.5 to 2.5 cm from the cutting edge of the blade closest to the bumps.

12. The handle according to claim 11, wherein the bumps are made of rigid plastic material.

13. The handle according to claim 11, wherein a transversal cross section of the handle is generally V shaped for more than 30% of the length of the handle.

14. The handle according to claim 11, wherein the number of bumps is from 4 to 20.

15. The handle according to claim 11, wherein the bumps have a cubic, frustoconical or hemispheric shape.

16. The handle according to claim 11, wherein the height of the bumps is constant.

17. The handle according to claim 11, wherein the height of the bumps is from 0.2 to 2.0 mm above the rigid plastic surface.

18. The handle according to claim 11, wherein the spacing between two adjacent bumps is from 0.2 to 5.0 mm.

19. The handle according to claim 11, wherein the width (or diameter for hemispheric or like bumps) of a bump is from 0.4 to 4.0 mm.

20. The handle according to claim 11, wherein from 2% to 30 of the surface of the rear half part of the top of the handle is made of elastomeric material.

21. A handle provided with an improved grip structure for a razor comprising:
a rigid plastic part and a compressible part; and
bumps provided on a front, lower side of the handle,
wherein the bumps are disposed adjacent to a razor head,
wherein the number of bumps is from 4 to 20, and
wherein the bumps have a cubic, frutoconical or hemispheric shape.

22. A handle provided with an improved grip structure for a razor comprising:
a rigid plastic part and a compressible part; and
bumps provided on a front, lower side of the handle,
wherein the bumps are disposed adjacent to a razor head,
wherein the number of bumps is from 4 to 20,
wherein the bumps have a cubic, frutoconical or hemispheric shape,
wherein the height of the bumps is from 0.2 to 2.0 mm above the rigid plastic surface, and
wherein spacing between two adjacent bumps is from 0.2 to 5.0 mm.
